(19) United States
(12) Patent Application Publication
(10) Pub. No.: US 2004/0022061 A1
(43) Pub. Date: Feb. 5, 2004

(54) Warning light device for attaching onto various objects

(76) Inventor: Jen Hsieh Shih, Chang Hua (TW)

Correspondence Address: Jen Hsieh SHIH, P.O. Box 63-298, Taichung, 406, TW

(21) Appl. No.: 10/212,646

(22) Filed: Aug. 2, 2002

(51) Int. Cl. F21V 21/00

(52) U.S. Cl. 362/396; 362/223

(57) ABSTRACT

A warning light device for attaching onto various objects includes a longitudinal housing having a longitudinal groove formed in the upper portion and formed between a pair of blades, and a light tube detachably received in the longitudinal groove of the longitudinal housing. The blades of the longitudinal housing may be engaged with the light tube for detachably receiving the light tube in the longitudinal groove of the longitudinal housing, and for allowing the light tube to be easily replaced with the other ones.

### BACKGROUND OF THE INVENTION

1. Field of the Invention

The present invention relates to a warning light device, and more particularly to a warning light device for attaching onto various objects, such as the curved portions of the vehicles.

2. Description of the Prior Art

Various kinds of typical warning light devices have been developed for attaching onto various objects, and for emitting the warning lights when required.

On example of the warning light devices is disclosed in U.S. Pat. No. 5,193,895 to Naruke et al. and comprises a number of chip-type light emitting elements mounted in alignment on a circuit board, and engaged in a narrow, ribbon-like light body made of synthetic resin. An elastic resin lens is then formed by pouring a molding silicone material into an opening of the narrow, ribbon-like synthetic resin light body.

The light emitting elements may be damaged inadvertently while molding the ribbon-like tube body. In addition, the silicone molding material should also be solidly filled and engaged in the ribbon-like light body. Furthermore, the light bulbs or the light emitting diodes may not be replaced by the other light bulbs or light emitting diodes when the light bulbs or the light emitting diodes are damaged or burned out, because the silicone molding material may not be molded into the ribbon-like body again after the new or replaced light members are engaged into the tube body.

The present invention has arisen to mitigate and/or obviate the afore-described disadvantages of the conventional warning light devices.

### SUMMARY OF THE INVENTION

The primary objective of the present invention is to provide a warning light device for attaching onto various objects, such as the curved portions of the vehicles.

The other objective of the present invention is to provide a warning light device having a hollow housing for detachably receiving and storing a light member and for allowing the light member to be easily disengaged from the housing and to be easily replaced with the other ones.

In accordance with one aspect of the invention, there is provided a warning light device for attaching onto various objects, the warning light device comprising a longitudinal housing including an upper portion having a longitudinal groove formed therein and defined between a pair of blades, and a light tube detachably received in the longitudinal groove of the longitudinal housing. The blades of the longitudinal housing are engaged with the light tube for detachably receiving the light tube in the longitudinal groove of the longitudinal housing.

The longitudinal groove of the housing includes a depth greater than a radius of the light tube and smaller than a diameter of the light tube. The blades of the longitudinal housing includes a distance smaller than a diameter of the light tube for detachably receiving the light tube in the longitudinal groove of the longitudinal housing.

A cover includes a cavity formed therein for receiving an end portion of the housing. The light tube includes one end received in the cavity of the cover, for allowing the light tube to be stably retained in the groove of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a warning light device in accordance with the present invention;

FIG. 2 is a perspective view of the warning light device;

FIG. 3 is a cross sectional view taken along lines 3-3 of FIG. 2; and

FIGS. 4, 5, 6 are schematic views illustrating the attachment of the warning light devices onto the curved portions of vehicles.

### DETAILED DESCRIPTION OF THE PREFERRED EMBODIMENT

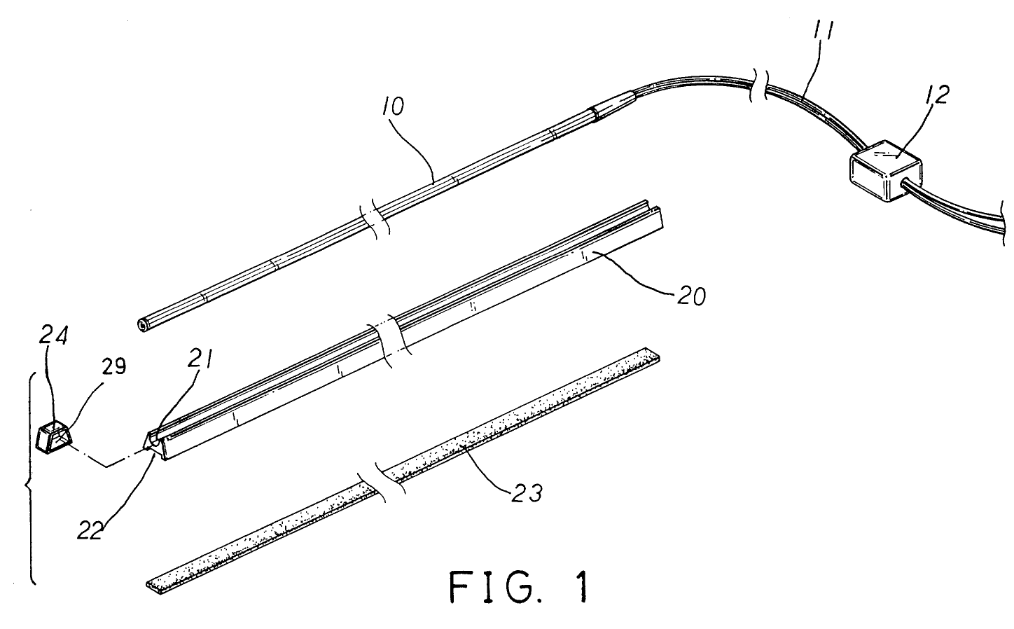

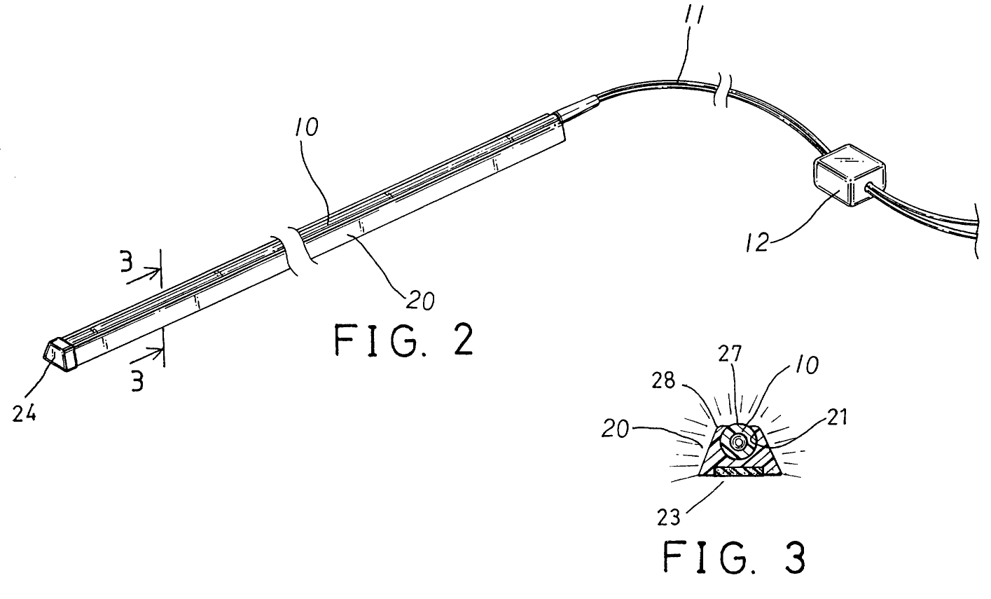

Referring to the drawings, and initially to FIGS. 1-4, a warning light device in accordance with the present invention comprises an illuminative light tube 10 coupled to an electric power supply with one or more wires 11 and with a transformer 12, for example, for generating the so-called cold light.

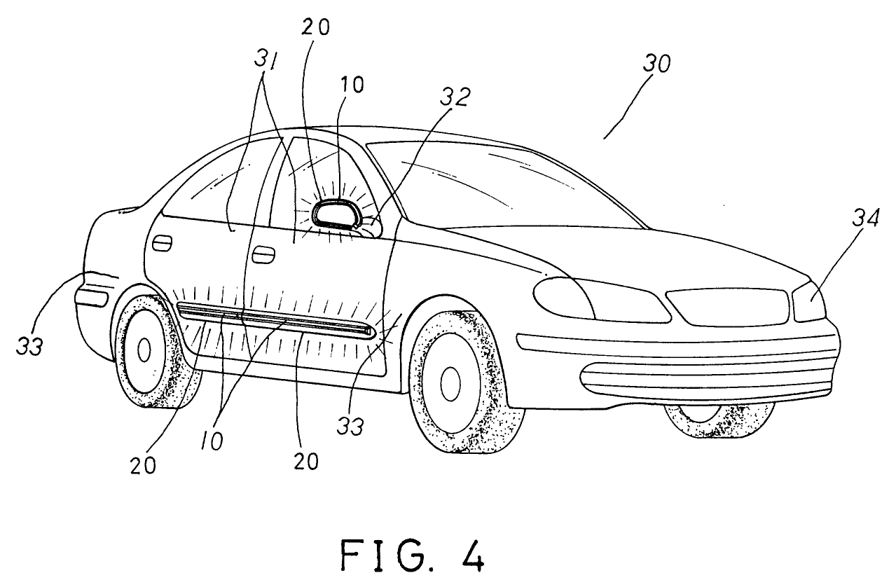

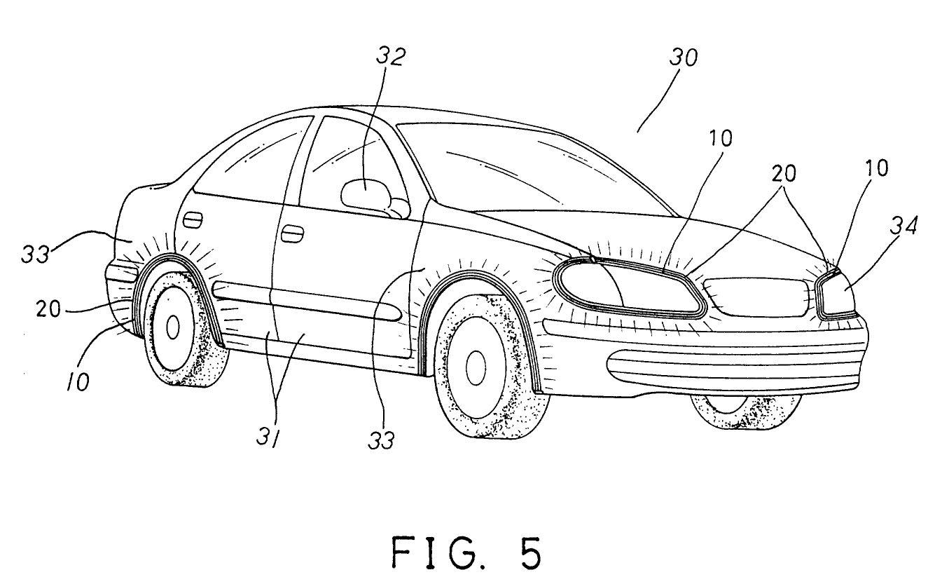

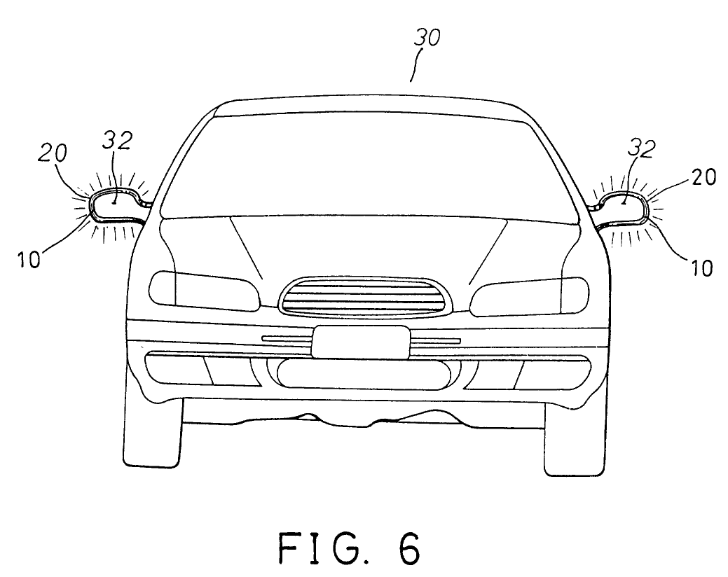

The warning light device further includes a longitudinal housing 20 having a longitudinal groove 21 formed in the upper portion thereof, and having a longitudinal recesses 22 formed in the lower portion thereof for receiving an adhesive layer 23 therein, and for attaching onto various objects, such as the vehicle 30 as shown in FIGS. 4-6.

The longitudinal housing 20 are made of flexible or soft materials and thus may be bent according to the various curvatures of the objects, such as that of the doors 31, or the rear view mirrors 32 or the other portions 33 of the vehicles 30, for allowing the longitudinal housing 20 to be attached onto the various curved portions of the vehicle.

The longitudinal housing 20 are also made of transparent or semi-transparent materials, for allowing the light generated by the light tube 10 to be transmitted through the longitudinal housing 20 and to be seen through the longitudinal housing 20, best shown in FIG. 3.

As best shown in FIG. 3, the longitudinal groove 21 of the longitudinal housing 20 includes a substantially circular cross section, having an opening 27 formed in the upper portion such that the longitudinal grove 21 of the housing 20 may be formed and defined by a pair of opposite flanges or blades 28, for resiliently and detachably retaining the light tube 10 within the longitudinal groove 21 of the longitudinal housing 20.

In addition, the longitudinal groove 21 of the longitudinal housing 20 includes a depth greater than the radius of the light tube 10, but smaller than the diameter of the light tube 10, such that the spaced distance between the blades 28 is smaller than diameter of the light tube 10, and such that the light tube 10 may be resiliently and detachably retained within the longitudinal groove 21 of the longitudinal housing 20 by the spring blades 28.

The longitudinal housing 20 further includes a cover 24 having a cavity 29 formed in one side thereof for receiving the end portion of the longitudinal housing 20, and/or for receiving the end portion of the light tube 10, for retaining the light tube 10 within the longitudinal groove 21 of the longitudinal housing 20.

The cover 24 is also preferably made of transparent or semi-transparent materials, for allowing lights to be transmitted through the cover 24 of the longitudinal housing 20.

When the light tube 10 has been damaged or burned out, the light tube 10 may be easily moved beyond the resilient blades 28 of the housing 20, and may thus be easily disengaged from the longitudinal groove 21 of the longitudinal housing 20, for allowing the light tube 10 to be replaced with the other light tubes 10.

Accordingly, the warning light device may be attached onto various objects, such as the curved portions of the vehicles, and includes a longitudinal housing having an opening for detachably receiving and storing a light member.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A warning light device for attaching onto various objects, said warning light device comprising:
a longitudinal housing including an upper portion having a longitudinal groove formed therein and defined between a pair of blades, and
a light tube detachably received in said longitudinal groove of said longitudinal housing,
said blades of said longitudinal housing being engaged with said light tube for detachably receiving said light tube in said longitudinal groove of said longitudinal housing.

2. The warning light device according to claim 1, wherein said longitudinal groove of said housing includes a depth greater than a radius of said light tube and smaller than a diameter of said light tube.

3. The warning light device according to claim 1, wherein said blades of said longitudinal housing includes a distance smaller than a diameter of said light tube for detachably receiving said light tube in said longitudinal groove of said longitudinal housing.

4. The warning light device according to claim 1 further comprising a cover having a cavity formed therein for receiving an end portion of said housing.

5. The warning light device according to claim 4, wherein said light tube includes a first end received in said cavity of said cover.
